(19) United States
(12) Patent Application Publication
(10) Pub. No.: US 2005/0049879 A1
(43) Pub. Date: Mar. 3, 2005

(54) Communication device capable of interworking between voice communications and text communications

(75) Inventors: Alexander Audu, Garland, TX (US); Chao Kan, Frisco, TX (US); Frederick H. Skoog, Colleyville, TX (US)

Correspondence Address: ALCATEL USA;INTELLECTUAL PROPERTY DEPARTMENT, 3400 W. PLANO PARKWAY, MS LEGL2, PLANO, TX, 75075, US

(73) Assignee: Alcatel

(21) Appl. No.: 10/651,271

(22) Filed: Aug. 28, 2003

(51) Int. Cl. G10L 15/00

(52) U.S. Cl. 704/277; 704/251

(57) ABSTRACT

A communication device is described herein that is capable of interworking between a voice application and a text application which enables a user to select whether they want to use voice communications or text communications to communicate with a user of a remote communication device (e.g., voice-only-capable communication device, text-only-capable communication device, voice-and-text capable communication device).

### BACKGROUND OF THE INVENTION

1. Field of the Invention

The present invention relates in general to the communications field and, in particular, to a communication device capable of interworking between a voice application and a text application which enables a user to select whether they want to use voice communications or text communications to communicate with a user of a remote communication device (e.g., voice-only-capable communication device, text-only-capable communication device, voice-and-text capable communication device).

2. Description of Related Art

Today in the telecommunications field, there is a communication device (e.g., traditional mobile phone) that enables a user to establish voice-to-voice communications or text-to-text communications with a user of a remote communication device (e.g., traditional mobile phone). Unfortunately, there is no communication device available today that enables a user to establish voice-to-text communications, text-to-voice communications, voice-to-voice communications or text-to-text communications with a user of a remote communication device. Although each one of these types of communications exist today, they do so in isolation as indicated below:
Voice-to-voice communications: The ability of two users to carry on a voice communication between communication devices.
Voice-to-text communications: Technology does exist to convert voice communications into text communications. For example, speak-and-spell and personal-secretary are applications of this technology.
Text-to-text communications: The ability of two users to carry on a text communication between communication devices.
Text-to-voice communications: Technology does exist to convert text communications into voice communications.

It would be desirable to have a communication device that would tie all of this technology together in a seamless manner such that a user could select whether they want to use voice communications or text communications to communicate with a user of a remote communication device that can be: (1) a voice-only-capable communication device; (2) a text-only-capable communication device; or (3) a voice-and-text capable communication device. Stated in another way, it would be desirable to have a communication device that would enable:
A user to use voice communications to communicate with a user of a voice-only-capable remote communication device.
A user to use voice communications to communicate with a user of a text-only-capable remote communication device.
A user to use text communications to communicate with a user of a text-only-capable remote communication device.
A user to use text communications to communication with a user of a voice-only-capable remote communication device.

These needs and other needs are addressed by the communication device of the present invention.

### BRIEF DESCRIPTION OF THE INVENTION

The present invention includes a communication device capable of interworking between a voice application and a text application which enables a user to select whether they want to use voice communications or text communications to communicate with a user of a remote communication device. In the preferred embodiment, the communication device includes a selector for enabling the user to select and activate one of the following: (1) a speech module and a speech input/output module for enabling the user to use voice communications to communicate with a user of a voice-capable remote communication device; (2) a text/speech module and a speech input/output module for enabling the user to use voice communications to communicate with a user of a text-capable remote communication device; (3) a text module and a text input/output module for enabling the user to use text communications to communicate with a user of a text-capable remote communication device; or (4) a speech/text module and a text input/output module for enabling the user to use text communications to communicate with a user of a voice-capable remote communication device. The present invention also includes methods for making and using the communication device.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram showing a user of a communication device configured in accordance with the present invention interacting with a user of a traditional communication device;

FIG. 2 is a block diagram showing the communication device shown in FIG. 1 configured to enable the user to use voice communications to communicate with a user of a traditional voice-only-capable communication device;

FIG. 3 is a block diagram of the communication device shown in FIG. 1 configured to enable the user to use voice communications to communicate with a user of a traditional text-only-capable communication device;

FIG. 4 is a block diagram of the communication device shown in FIG. 1 configured to enable the user to use text communications to communicate with a user of a traditional text-only-capable communication device;

FIG. 5 is a block diagram of the communication device shown in FIG. 1 configured to enable the user to use text communications to communicate with a user of a traditional voice-only-capable communication device;

FIG. 6 is a flowchart of the basic steps of a preferred method for using the communication device shown in FIG. 1 in accordance with the present invention; and

FIG. 7 is a flowchart showing the basic steps of a preferred method for making the communication device shown in FIG. 1 in accordance with the present invention.

### DETAILED DESCRIPTION OF THE DRAWINGS

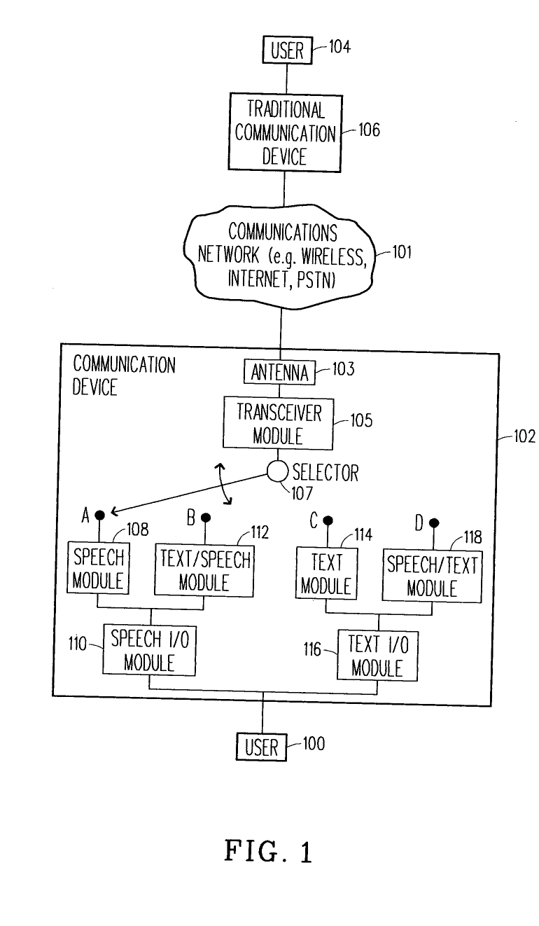

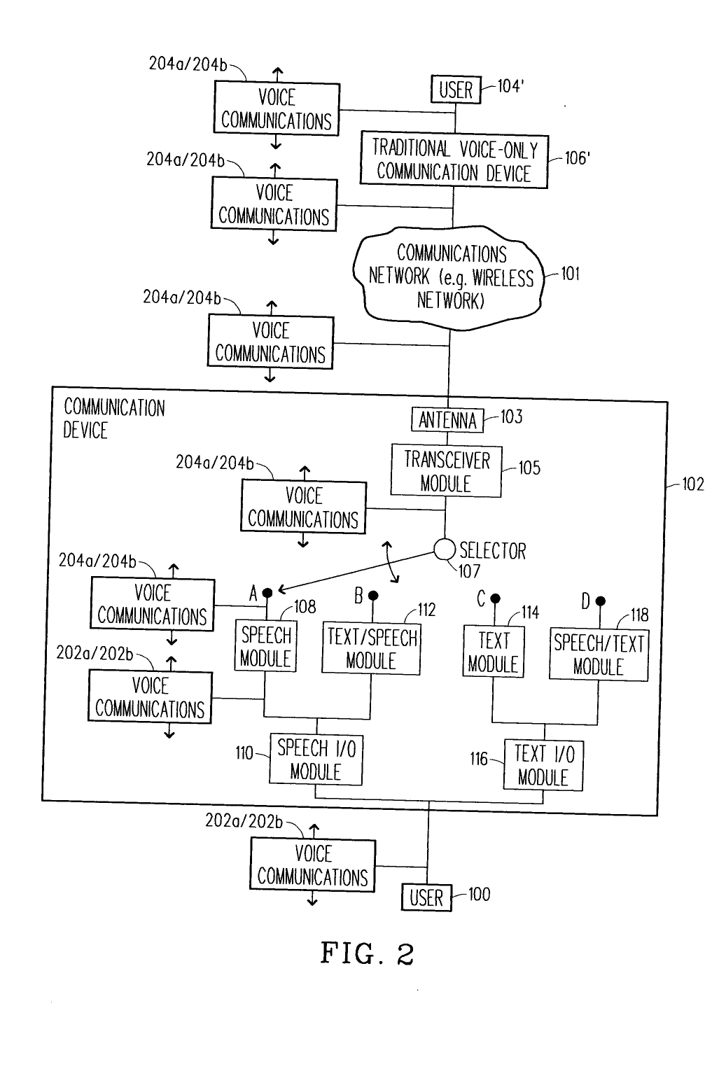

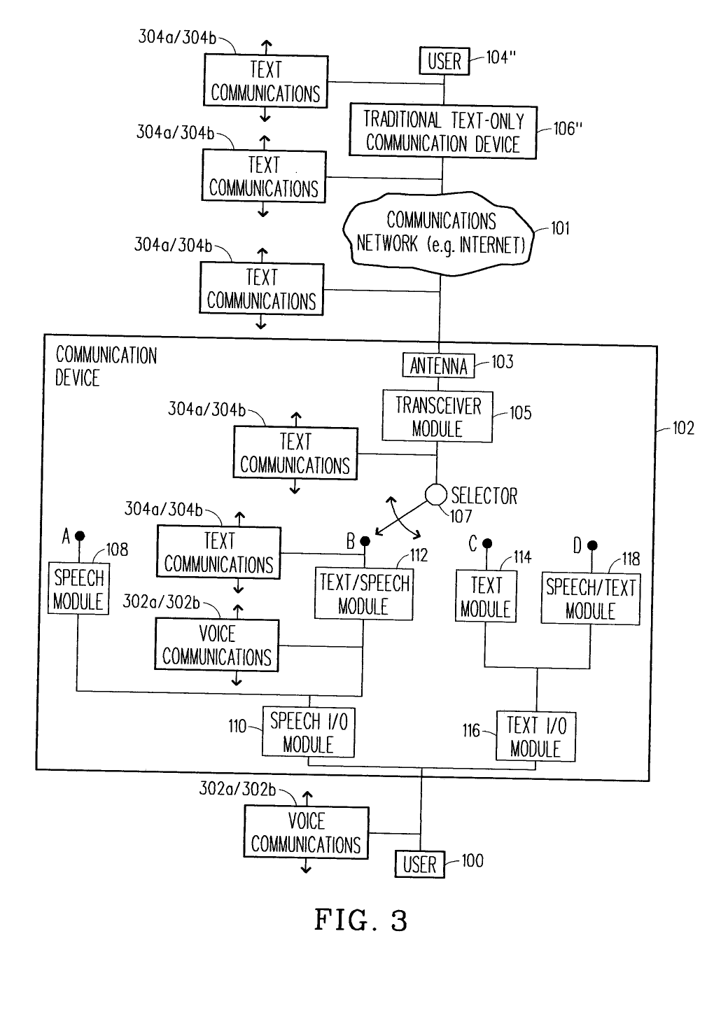

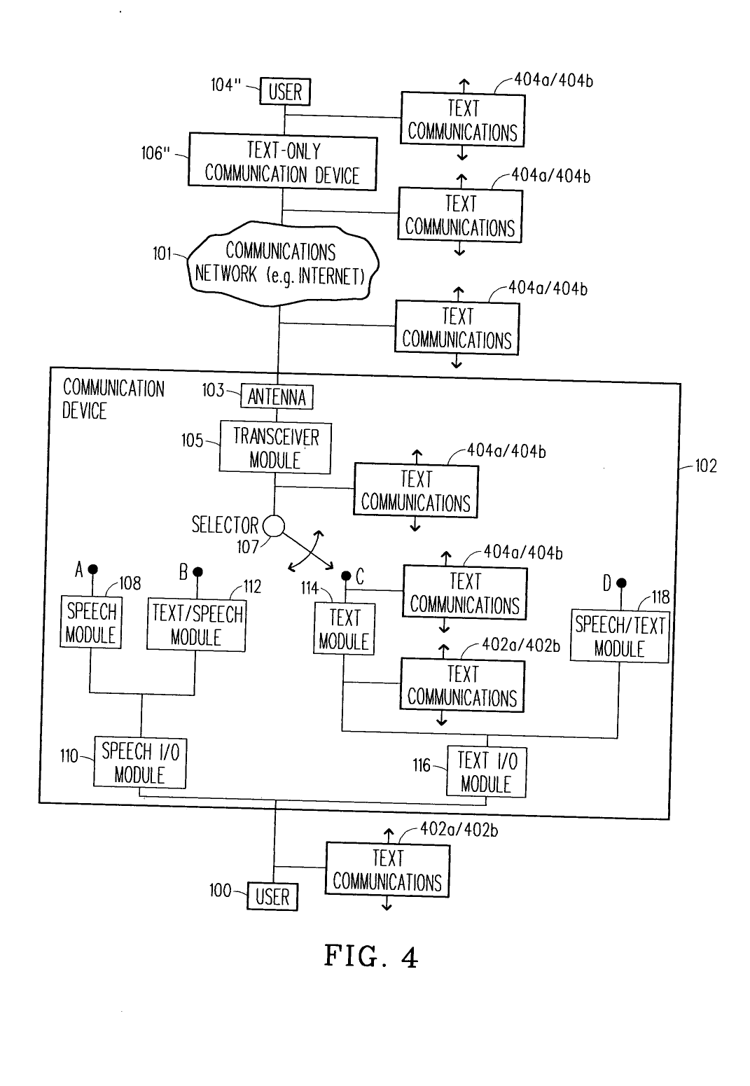

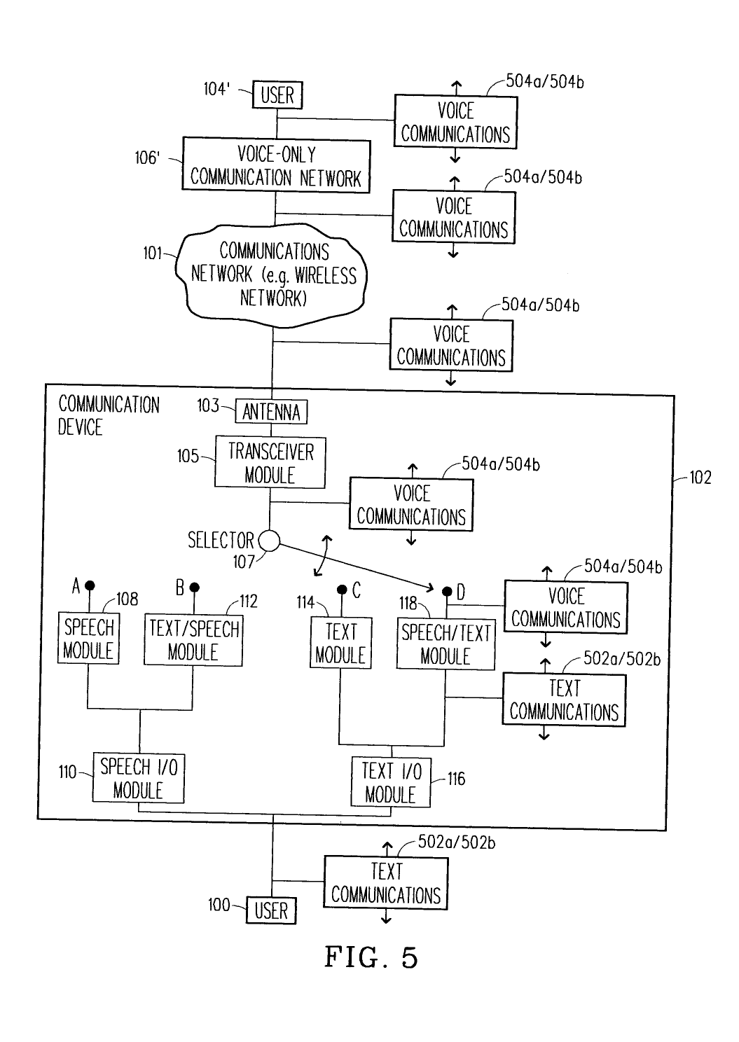

Referring to FIG. 1, there is shown a block diagram illustrating a user 100 of a communication device 102 configured in accordance with the present invention interacting a user 104 of a traditional communication device 106 (e.g., remote communication device 106). Basically, the communication device 102 is capable of interworking between a voice application and a text application which enables the user 100 to select whether they want to use voice communications or text communications to communicate with the user 104 of the remote communication device 106. In particular, the communication device 102 is configured to enable the user 100 to select whether they want to use voice communications or text communications to communicate in real time through a communications network 101 (e.g., wireless network, Internet, public switched telephone network (PSTN)) with the user 104 of the traditional communication device 106 that can be: (1) a voice-only-capable communication device 106′(see FIGS. 2 and 5); (2) a text-only-capable communication device 10611 (see FIGS. 3 and 4); or (3) a voice-and-text capable communication device (not shown). Stated in another way, the communication device 102 can enable:
The user 100 to use voice communications to communicate with a user 104′ of a voice-only-capable remote communication device 106′(see FIG. 2).
The user 100 to use voice communications to communicate with a user 104″ of a text-only-capable remote communication device 106″ (see FIG. 3).
The user 100 to use text communications to communicate with a user 104″ of a text-only-capable remote communication device 106″ (see FIG. 4).
The user 100 to use text communications to communication with a user 104′ of a voice-only-capable remote communication device 106′ (see FIG. 5).

It should be appreciated that a voice-and-text capable communication device 106 can be used instead of the voice-only-capable remote communication device 106′ and the text-only-capable remote communication device 106″.

It should also be appreciated that certain components associated with the communication device 102 like the modulator, demodulator, operator interface etc. . . . are well known in the industry and as such are not described herein. Therefore, the description provided below in relation to the communication device 102 describes only the components that enable the interworking between a voice application and a text application which allows the user 100 to select whether they want to use voice communications or text communications to communicate with the user 104 of the remote communication device 106.

As shown, the communication device 102 includes an antenna 103 (optional), a transceiver (transmit/receive) module 105 and a selector 107 (e.g., switch 107, push-buttons/keys 107, voice-activated selector 107) that enables the user 100 to select and activate one of the following:
A speech module 108 and a speech input/output module 110 (e.g., microphone/speaker 110) that enables the user 100 to use voice communications to communicate with the user 104′ of the voice-only-capable remote communication device 106′ (see FIG. 2).
A text/speech module 112 and the speech input/output module 110 (e.g., microphone/speaker 110) that enables the user 100 to use voice communications to communicate with the user 104″ of a text-only-capable remote communication device 106″ (see FIG. 3).
A text module 114 and a text input/output module 116 (e.g., buttons/screen 116, keyboard/screen 116) that enables the user 100 to use text communications to communicate with the user 104″ of a text-only-capable remote communication device 106″ (see FIG. 4).
A speech/text module 118 and the text input/output module 116 (e.g., buttons/screen 116, keyboard/screen 116) that enables the user 100 to use text communications to communicate with the user 104′ of the voice-only-capable remote communication device 106′ (see FIG. 5).

The user 100 can select and activate one of the components 108, 112, 114 and 118 after they receive a communication (e.g., voice communications, text communications) from the user 104 of the remote communication device 106. For instance upon receiving a voice communication from user 104, the communication device 102 may output the voice communication to the user 100 and then let the user 100 select if they want to use voice communications (see FIG. 2) or text communications (see FIG. 5) to communicate with user 104. Likewise upon receiving a text communication from user 104, the communication device 102 may output the text communication to the user 100 and then let the user 100 select if they want to use voice communications (see FIG. 3) or text communications (see FIG. 4) to communicate with user 104. It should be appreciated that the user 100 can switch back-and-forth between voice and text communications during the conversation with user 104.

The user 100 can also select and activate one of the components 108, 112, 114 and 118 to initiate communications (e.g., voice communications, text communications) with the user 104 of the remote communication device 106. To initiate the call the user 100 may need to know the capabilities of the communication device 106 being used by user 104. This is often not troublesome since the user 100 would typically know if user 104 is using a voice-only-capable communication device 106′, a text-only-capable communication device 106″ or a voice-and-text capable communication device 106. Alternatively, to initiate the call the user 100 may not need to know the capabilities of the communication device 106 being used by user 104 if there is a middleware translation such as a user preference server used within the network 101 that can help the user 100 to initiate the call in the correct form to user 104.After the call is initiated the user 100 can select between using voice and text communications during the conversation with user 104. In fact, the user 100 can switch back-and-forth between voice and text communications during the conversation with user 104.

A more detailed discussion about how the user 100 can select whether they want to use voice communications or text communications to communicate with the user 104 of the remote communication device 106 and about each of the components 108, 112, 116 and 118 is provided below with respect to FIGS. 2-5.

Referring to FIG. 2, there is a block diagram showing the communication device 102 configured to enable the user 100 to use voice communications to communicate with the user 104′ of a traditional voice-only-capable communication device 106′ (e.g., mobile phone 106′, land-line phone 106′, graphical proxy terminal 106′). In this configuration, the user 100 moved the selector 107 to position “A” such that the speech module 108 and the speech input/output module 110 are activated and enabled so the user 100 can use voice communications 202a and 202b to communicate in real time through communication network 101 (e.g., wireless network 101) with the user 104′ of the voice-only-capable remote communication device 106′.

As shown, the user 100 can receive/hear voice communications 202a from the speech input/output module 110 (e.g., microphone/speaker 110) which were processed by the speech module 108 after being received by the antenna 103 and transceiver module 105 as voice communications 204a from the user 104′ of the voice-only-capable remote communication device 106′. The user 100 can also output/speak voice communications 202b to the speech input/output module 110 which are processed by the speech module 108 and transmitted as voice communications 204b by the transceiver module 105 and antenna 103 to the user 104′ of the voice-only-capable remote communication device 106′. It should be appreciated that the user 100 can hear the actual voice of user 104′ and vice versa.

Referring to FIG. 3, there is a block diagram showing the communication device 102 configured to enable the user 100 to use voice communications to communicate with the user 104″ of a traditional text-only-capable communication device 106″ (e.g., personal digital assistant 106″, personal computer 106″, graphical proxy terminal 106″). In this configuration, the user 100 moved the selector 107 to position “B” such that the text/speech module 112 and the speech input/output module 110 (e.g., microphone/speaker 110) are activated and enabled so the user 100 can use voice communications 302a and 302b to communicate in real time through the communications network 101 (e.g., Internet 101) with the user 104″ of the text-only-capable remote communication device 106″.

As shown, the user 100 can receive/hear voice communications 302a (e.g., computer generated/mechanical voice communications 302a) from the speech input/output module 110 (e.g., microphone/speaker 110) which have been processed by the text/speech module 112 and converted into the received voice communications 302a from text communications 304a (e.g., Instant Messages 304a) transmitted from the user 104″ of the text-only-capable remote communication device 106″. The user 100 can also output/speak voice communications 302b into the speech input/output module 110 which are processed by the text/speech module 112 and converted into text communications 304b that are processed by the antenna 103 and the transceiver module 105 and transmitted to the user 104″ of the text-only-capable remote communication device 106″. It should be appreciated that the communication device 102 having the selector 107 positioned at “B” could further enhance the popularity of Instant Message (IM) technology by enabling voice-to-IM communications and vice versa (see also FIG. 5).

Referring to FIG. 4, there is a block diagram showing the communication device 102 configured to enable the user 100 to use text communications 402a and 402b to communicate with the user 104″ of a traditional text-only-capable communication device 106″ (e.g., personal digital assistant 106″, personal computer 106″, graphical proxy terminal 106″). In this configuration, the user 100 moved the selector 107 to position “C” such that the text module 114 and the text input/output module 116 (e.g., buttons/screen 116, keyboard/screen 116) are activated and enabled so the user 100 can use text communications 402a and 402b to communicate in real time through communications network 101 (e.g., Internet 101) with the user 104″ of a text-only-capable remote communication device 106″.

As shown, the user 100 can receive/see text communications 402a (e.g., IM messages 402a) from the text input/output module 116 which have been processed by the text module 114 after being received as text communications 404a (e.g., IM messages 404a) from the user 104″ of the text-only-capable remote communication device 106″. The user 100 can also output/type text communications 404b (e.g., IM messages 404b) into the text input/output module 116 which are processed by the text module 114 and transmitted by the transceiver module 105 and antenna 103 as text communications 404b to the user 104″ of the text-only-capable remote communication device 106′.

Referring to FIG. 5, there is a block diagram showing the communication device 102 configured to enable the user 100 to use text communications to communicate with the user 104′ of a traditional voice-only-capable communication device 106′ (e.g., mobile phone 106′, land-line phone 106′, graphical proxy terminal 106′). In this configuration, the user 100 moved the selector 107 to position “D” such that a speech/text module 118 and the text input/output module 116 (e.g., buttons/screen 116, keyboard/screen 116) are activated and enabled so the user 100 can use text communications 502a and 502b (e.g., IM messages 502a and 502b) to communicate in real time through communications network 101 (e.g., wireless network 101) with the user 104′ of the voice-only-capable remote communication device 106′.

As shown, the user 100 can receive/read text communications 502a (e.g., IM messages 502a) from the text input/output module 116 which have been processed by the speech/text module 118 and converted into the received text communications 502a from voice communications 504a transmitted from the user 104′ of the voice-only-capable remote communication device 106″. The user 100 can also output/type text communications 502b (e.g., IM messages 502b) into the text input/output module 116 which are processed by the speech/text module 118 and converted into voice communications 504b (e.g., computer generated/mechanical voice communications 504b) that are transmitted from the antenna 103 and the transceiver module 105 to the user 104′ of the voice-only-capable remote communication device 106′. It should be appreciated that the communication device 102 having the selector 107 positioned at “D” could further enhance the popularity of IM technology by enabling voice-to-IM communications and vice versa (see also FIG. 3). For instance, a major benefit of this particular configuration is that it allows the user 100 who may be attending a meeting to use silent textual communications 502a and 504b to communicate with a voice peer 104′ while not having to leave the meeting room to speak aloud to communicate with the voice peer 104′.

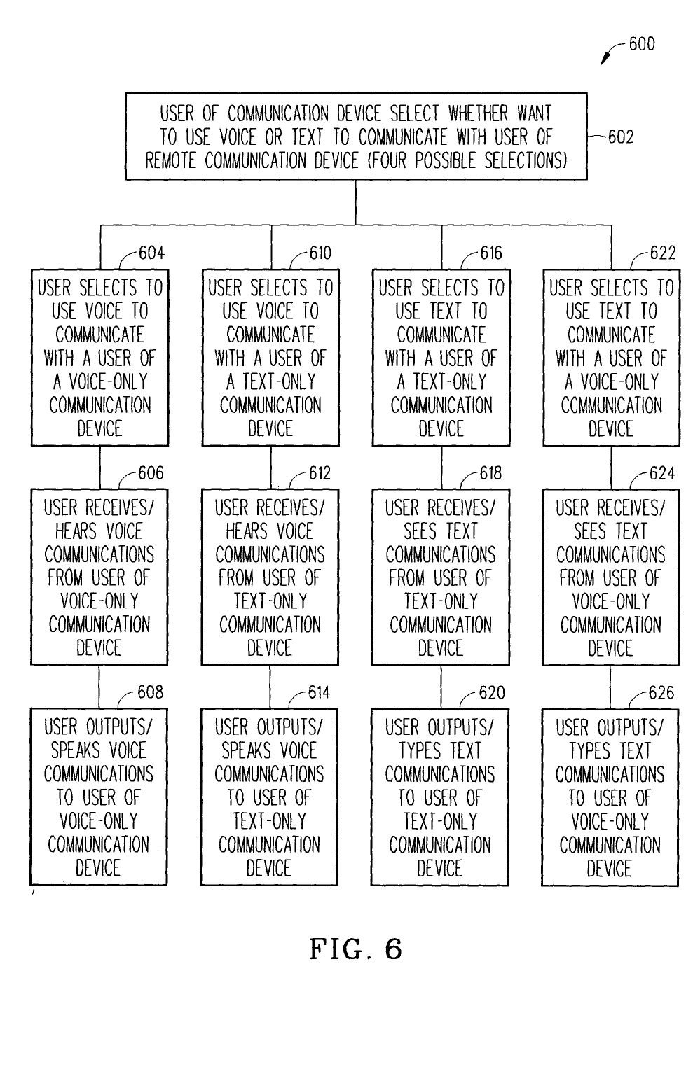

Referring to FIG. 6, there is a flowchart showing the basic steps of a preferred method 600 for using the communication device 102 in accordance with the present invention. Beginning at step 602, the user 100 can select whether they want to use voice communications or text communications to communicate with the user 104 of a remote communication device 106 by letting the user 100 activate one of the following:
The speech module 108 and the speech input/output module 110 (e.g., microphone/speaker 110) that enables the user 100 to use voice communications to communicate with the user 104′ of the voice-only-capable remote communication device 106′ (see step 604 and FIG. 2). In this configuration, the user 100 of the communication device 102 can receive/hear voice communications 202a from the user 104′ that speaks voice communications 204a into the voice-only-capable remote communication device 106′ (step 606). And, the user 100 of the communication device 102 can output/speak voice communications 202b to the user 104′ that hears voice communications 204b from the voice-only-capable remote communication device 106′(step 608).
The text/speech module 112 and the speech input/output module 110 (e.g., microphone/speaker 110) that enables the user 100 to use voice communications to communicate with the user 104″ of a text-only-capable remote communication device 106″ (see step 610 and FIG. 3). In this configuration, the user 100 of the communication device 102 can receive/hear computer generated voice communications 302a from the user 104″ that inputs text communications 304a into the text-only-capable remote communication device 106″ (step 612). And, the user 100 of the communication device 102 can output/speak voice communications 302b to the user 104″ that receives/sees text communications 304b from the text-only-capable remote communication device 106″ (step 614).
The text module 114 and the text input/output module 116 (e.g., buttons/screen 116, keyboard/screen 116) that enables the user 100 to use text communications to communicate with the user 104 of a text-only-capable remote communication device 106″ (see step 616 and FIG. 4). In this configuration, the user 100 of the communication device 102 can receive/see text communications 402a from the user 104″ that inputs text communications 404a into the text-only-capable remote communication device 106″ (step 618). And, the user 100 of the communication device 102 can output/type text communications 402b to the user 104″ that receives/sees text communications 404b from the text-only-capable remote communication device 106″ (step 620).
The speech/text module 118 and the text input/output module 116 (e.g., buttons/screen 116, keyboard/screen 116) that enables the user 100 to use text communications to communicate with the user 104′ of the voice-only-capable remote communication device 106′ (see step 622 and FIG. 5). In this configuration, the user 100 of the communication device 102 can receive/see text communications 502a from the user 104′ that inputs voice communications 504a into the voice-only-capable remote communication device 106′ (step 624). And, the user 100 of the communication device 102 can output/type text communications 502b to the user 104′ that receives/hears computer generated voice communications 504b from the voice-only-capable remote communication device 106′ (step 626).

Again, it should be appreciated that the user 104 can use a voice-and-text capable communication device 106 instead of the voice-only-capable remote communication device 106′ and the text-only-capable remote communication device 106″.

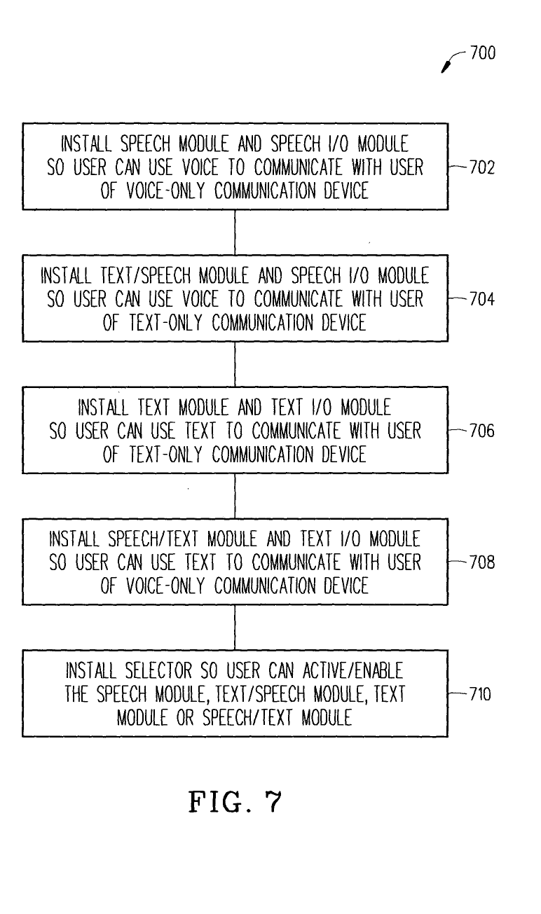

Referring to FIG. 7, there is a flowchart showing the basic steps of a preferred method 700 for making the communication device 102 so that it is capable of interworking between a voice application and a text application which enables the user 100 to select whether they want to use voice communications or text communications to communicate with the user 104 of the remote communication device 106. At step 702, the speech module 108 and the speech input/output module 110 (e.g., microphone/speaker 110) are installed in the communication device 102 which enable the user 100 to use voice communications to communicate with the user 104′ of the voice-only-capable remote communication device 106′ (see steps 604, 606 and 608 and FIG. 2). At step 704, the text/speech module 112 and the speech input/output module 110 (e.g., microphone/speaker 110) are installed within the communication device 102 which enable the user 100 to use voice communications to communicate with the user 104 of a text-only-capable remote communication device 106″ (see steps 610, 612 and 614 and FIG. 3). At step 706, the text module 114 and the text input/output module 116 (e.g., buttons/screen 116, keyboard/screen 116) are installed within the communication device which enable the user 100 to use text communications to communicate with the user 104 of a text-only-capable remote communication device 106″ (see steps 616, 618 and 620 and FIG. 4). At step 708, the speech/text module 118 and the text input/output module 116 (e.g., buttons/screen 116, keyboard/screen 116) are installed within the communication device 102 which enable the user 100 to use text communications to communicate with the user 104′ of the voice-only-capable remote communication device 106′ (see steps 622, 624 and 624 and FIG. 5). At step 710, the selector 107 is installed within the communication device 102 that enables the user 100 to activate and enable the speech module 108, the text/speech module 112, the text module 114 or the speech/text module 118 (see FIGS. 2-5).

Again, the technology exists today to make in isolation the speech module 108, the text/speech module 112, the text module 114 or the speech/text module 118. However, the communication device 102 ties all of the technology associated with components 108, 112, 114 and 118 together in a seamless manner such that the user 100 could select whether they want to use voice communications or text communications to communicate with the user 104 of the remote communication device 106 (see FIG. 1).

Following is a list of some of the other features and advantages associated with the present invention:
This invention provides a communication device 102 and method 600 for interworking between a text-capable end-point and a voice-capable endpoint for the purpose of communication in real time.
The communication device 102 can have a selector 107 that is a physical switch, push-buttons (alpha-numeric keys) or could even be a voice-activated switch that enables the user 100 to configure the communication device 102.
The communication device 102 can be a mobile phone, personal computer, personal digital assistant (PDA), land-line phone or a graphical proxy terminal.
The present invention allows: (1) communications between a text-mode endpoint and a speech-mode endpoint; (2) communications between a text-mode endpoint and another text-mode endpoint; and (3) allows communications between a speech-mode endpoint and another speech-mode endpoint. The advantages associated with (1) and (2) are that a user 100 of the text-mode endpoint can be involved in a silent conversation without disturbing the quietness of his/her immediate surroundings. (for example, in a meeting).
It should be appreciated that user 100 and user 104 can both use a communication device 102 to communicate with one another in a wide variety of ways.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

1. A communication device capable of interworking between a voice application and a text application which enables a user to select whether they want to use voice communications or text communications to communicate with a user of a remote communication device.

2. The communication device of claim 1, wherein said remote communication device is a voice-only-capable communication device.

3. The communication device of claim 1, wherein said remote communication device is a text-only-capable communication device.

4. The communication device of claim 1, wherein said remote communication device is a voice-and-text capable communication device.

5. The communication device of claim 1, wherein said user is capable of changing back-and-forth between voice communications and text communications during a conversation with the user of the remote communication device.

6. A communication device comprising:
a selector for enabling a user to select and activate one of the following:
a speech module and a speech input/output module for enabling the user to use voice communications to communicate with a user of a voice-capable remote communication device;
a text/speech module and a speech input/output module for enabling the user to use voice communications to communicate with a user of a text-capable remote communication device;
a text module and a text input/output module for enabling the user to use text communications to communicate with a user of a text-capable remote communication device; or
a speech/text module and a text input/output module for enabling the user to use text communications to communicate with a user of a voice-capable remote communication device.

7. The communication device of claim 6, wherein when said speech module and said speech input/output module are selected and activated then the user can use voice communications to communicate with the user of the voice-capable remote communication device by:
receiving voice communications from said speech input/output module which were processed by said speech module after being received as voice communications from the user of the voice-capable remote communication device; and
outputting voice communications into said speech input/output module which are processed by said speech module and transmitted as voice communications to the user of the voice-capable remote communication device.

8. The communication device of claim 6, wherein when said text/speech module and said speech input/output module are selected and activated then the user can use voice communications to communicate with the user of the text-capable communication device by:
receiving voice communications from said speech input/output module which have been processed by said text/speech module and converted into the received voice communications from text communications transmitted from the user of the text-capable remote communication device; and
outputting voice communications into said speech input/output module which are processed by said text/speech module and converted into text communications that are transmitted to the user of the text-capable remote communication device.

9. The communication device of claim 6, wherein when said text module and said text input/output module are selected and activated then the user can use text communications to communicate with the user of the text-capable remote communication device by:
receiving text communications from said text input/output module which have been processed by said text module after being received as text communications from the user of the text-capable remote communication device; and
outputting text communications into said text input/output module which are processed by said text module and transmitted as text communications to the user of the text-capable remote communication device.

10. The communication device of claim 6, wherein when said speech/text module and said text input/output module are selected and activated then the user can use text communications to communicate with the user of the voice-capable remote communication device by:
receiving text communications from said text input/output module which have been processed by said speech/text module and converted into the received text communications from voice communications transmitted from the user of the voice-capable remote communication device; and
outputting text communications into said text input/output module which are processed by said speech/text module and converted into voice communications that are transmitted to the user of the voice-capable remote communication device.

11. The communication device of claim 6, wherein said text communications are instant messages.

12. The communication device of claim 6, wherein said communication device is a mobile phone.

13. The communication device of claim 6, wherein said communication device is a personal computer.

14. The communication device of claim 6, wherein said communication device is a personal digital assistant.

15. The communication device of claim 6, wherein said communication device is a land-line phone.

16. The communication device of claim 6, wherein said communication device is a graphical proxy terminal.

17. A method for using a communication device, said method comprising the step of:
enabling a user to select whether they want to use voice communications or text communications to communicate with a user of a remote communication device by letting the user to select and activate one of the following:
a speech module and a speech input/output module for enabling the user to use voice communications to communicate with a user of a voice-capable remote communication device;
a text/speech module and a speech input/output module for enabling the user to use voice communications to communicate with a user of a text-capable remote communication device;
a text module and a text input/output module for enabling the user to use text communications to communicate with a user of a text-capable remote communication device; or
a speech/text module and a text input/output module for enabling the user to use text communications to communicate with a user of a voice-capable remote communication device.

18. The method of claim 17, wherein when said speech module and said speech input/output module are selected and activated then the user can use voice communications to communicate with the user of the voice-capable remote communication device by:
receiving voice communications from said speech input/output module which were processed by said speech module after being received as voice communications from the user of the voice-capable remote communication device; and
outputting voice communications into said speech input/output module which are processed by said speech module and transmitted as voice communications to the user of the voice-capable remote communication device.

19. The method of claim 17, wherein when said text/speech module and said speech input/output module are selected and activated then the user can use voice communications to communicate with the user of the text-capable communication device by:
receiving voice communications from said speech input/output module which have been processed by said text/speech module and converted into the received voice communications from text communications transmitted from the user of the text-capable remote communication device; and
outputting voice communications into said speech input/output module which are processed by said text/speech module and converted into text communications that are transmitted to the user of the text-capable remote communication device.

20. The method of claim 17, wherein when said text module and said text input/output module are selected and activated then the user can use text communications to communicate with the user of the text-capable remote communication device by:
receiving text communications from said text input/output module which have been processed by said text module after being received as text communications from the user of the text-capable remote communication device; and
outputting text communications into said text input/output module which are processed by said text module and transmitted as text communications to the user of the text-capable remote communication device.

21. The method of claim 17, wherein when said speech/text module and said text input/output module are selected and activated then the user can use text communications to communicate with the user of the voice-capable remote communication device by:
receiving text communications from said text input/output module which have been processed by said speech/text module and converted into the received text communications from voice communications transmitted from the user of the voice-capable remote communication device; and
outputting text communications into said text input/output module which are processed by said speech/text module and converted into voice communications that are transmitted to the user of the voice-capable remote communication device.

22. The method of claim 17, wherein said text communications are instant messages.

23. The method of claim 17, wherein said communication device is one of the following:
a mobile phone;
a personal computer;
a personal digital assistant;
a land-line phone; or
a graphical proxy terminal.

24. A method for making a communication device capable of interworking between a voice application and a text application which enables a user to select whether they want to use voice communications or text communications to communicate with a user of a remote communication device, said method comprising the steps of:
installing, within said communication device, a speech module and a speech input/output module for enabling the user to use voice communications to communicate with a user of a voice-capable remote communication device;
installing, within said communication device, a text/speech module which is coupled with the speech input/output module for enabling the user to use voice communications to communicate with a user of a text-capable remote communication device;
installing, within said communication device, a text module and a text input/output module for enabling the user to use text communications to communicate with a user of a text-capable remote communication device; and
installing, within said communication device, a speech/text module which is coupled with the text input/output module for enabling a user to use text communications to communicate with a user of a voice-capable remote communication device;
installing, within said communication device, a selector that enables a user to select and activate said speech module, said text/speech module, said text module or said speech/text module.

25. The method of claim 24, wherein when said speech module and said speech input/output module are selected and activated then the user can use voice communications to communicate with the user of the voice-capable remote communication device by:
receiving voice communications from said speech input/output module which were processed by said speech module after being received as voice communications from the user of the voice-capable remote communication device; and
outputting voice communications into said speech input/output module which are processed by said speech module and transmitted as voice communications to the user of the voice-capable remote communication device.

26. The method of claim 24, wherein when said text/speech module and said speech input/output module are selected and activated then the user can use voice communications to communicate with the user of the text-capable communication device by:
receiving voice communications from said speech input/output module which have been processed by said text/speech module and converted into the received voice communications from text communications transmitted from the user of the text-capable remote communication device; and
outputting voice communications into said speech input/output module which are processed by said text/speech module and converted into text communications that are transmitted to the user of the text-capable remote communication device.

27. The method of claim 24, wherein when said text module and said text input/output module are selected and activated then the user can use text communications to communicate with the user of the text-capable remote communication device by:
receiving text communications from said text input/output module which have been processed by said text module after being received as text communications from the user of the text-capable remote communication device; and
outputting text communications into said text input/output module which are processed by said text module and transmitted as text communications to the user of the text-capable remote communication device.

28. The method of claim 24, wherein when said speech/text module and said text input/output module are selected and activated then the user can use text communications to communicate with the user of the voice-capable remote communication device by:
receiving text communications from said text input/output module which have been processed by said speech/text module and converted into the received text communications from voice communications transmitted from the user of the voice-capable remote communication device; and
outputting text communications into said text input/output module which are processed by said speech/text module and converted into voice communications that are transmitted to the user of the voice-capable remote communication device.

29. The method of claim 24, wherein said text communications are instant messages.

30. The method of claim 24, wherein said communication device is one of the following:
a mobile phone;
a personal computer;
a personal digital assistant;
a land-line phone; or
a graphical proxy terminal.
